(19) United States
(12) Patent Application Publication
(10) Pub. No.: US 2025/0148660 A1
(43) Pub. Date: May 8, 2025

(54) TECHNIQUES FOR ENABLING ON-DEVICE INK STROKE PROCESSING

(71) Applicant: Microsoft Technology Licensing, LLC, Redmond, WA (US)

(72) Inventors: Biyi FANG, Kirkland, WA (US); Yibo SUN, Bellevue, WA (US); Zhe WANG, Redmond, WA (US)

(73) Assignee: Microsoft Technology Licensing, LLC, Redmond, WA (US)

(21) Appl. No.: 18/503,606

(22) Filed: Nov. 7, 2023

(51) Int. Cl. G06T 11/00

(52) U.S. Cl. CPC G06T 11/001

(57) ABSTRACT

A data processing system implements obtaining device information and performance requirements information for a resource-constrained computing device; analyzing the device information and the performance requirements information to determine an amount to compress one or more machine learning models to permit the resource-constrained computing device to operate the one or more machine learning models on the resource-constrained computing device, the one or more machine learning models including a stroke classification model for classifying digital ink stroke information as handwriting or a drawing; compressing the one or more machine learning models to permit the one or more machine learning models to operate on the resource-constrained computing device to generate one or more compressed machine learning models; and deploying the one or more compressed machine learning models to the resource-constrained computing device to process ink stroke information captured by a user interface of the resource-constrained computing device.

### BACKGROUND

Digital ink enables users to draw and write on a computing device using a stylus, a finger, a mouse, or other input device. Many of the features associated with digital ink rely on deep learning models to analyze user inputs to support these features. These features include determining whether digital ink strokes input by a user include handwriting or a drawing. The models used include stroke classification models that determine whether the digital ink strokes input by the user are handwriting or a drawing. Other types of deep learning models may be used to analyze digital ink strokes to provide different types of services to the user.

Due to the size and complexity of the models used to implement these services, the services are typically implemented by cloud-based service platforms. These platforms receive ink stroke information captured by the client device of users and analyze the ink stroke information to provide various services to the users. However, this approach requires network connectivity, and the user experience will suffer when network connectivity is slow. An alternative to this approach is to implement an instance of the deep learning model locally on the user device, but many devices do not have the computing, memory, and/or storage resources required to support a local instance of the deep learning models. Hence, there is a need for improved systems and methods that provide a technical solution for implementing such deep learning models on resource-constrained devices.

### SUMMARY

An example data processing system according to the disclosure may include a processor and a machine-readable medium storing executable instructions. The instructions when executed cause the processor alone or in combination with other processors to perform operations including obtaining, via a model compression unit, device information and performance requirements information for a resource-constrained computing device; analyzing, via the model compression unit, the device information and the performance requirements information to determine an amount to compress one or more machine learning models to permit the resource-constrained computing device to operate the one or more machine learning models on the resource-constrained computing device; compressing, via the model compression unit, the one or more machine learning models to permit the one or more machine learning models to operate on the resource-constrained computing device to generate one or more compressed machine learning models by altering a structure of the one or more machine learning models to require fewer resources when executed than an uncompressed version of the one or more machine learning models; and deploying the one or more compressed machine learning models to the resource-constrained computing device to process ink stroke information captured by a user interface of the resource-constrained computing device.

An example method implemented in a data processing system includes obtaining device information for a resource-constrained computing device; selecting a set of compressed machine learning models to be implemented on the resource-constrained computing device based on the device information and performance requirements information indicating performance constraints for compressed models to be implemented on the resource-constrained computing device; and deploying the one or more compressed machine learning models to the resource-constrained computing device to process ink stroke information captured by a user interface of the resource-constrained computing device.

An example data processing system according to the disclosure may include a processor and a machine-readable medium storing executable instructions. The instructions when executed cause the processor alone or in combination with other processors to perform operations including obtaining, via a digital ink processing pipeline, digital ink stroke information representing handwritten text; analyzing the digital ink stroke information using a temporal line grouping model trained to receive the digital ink stroke information as an input and to output information identifying lines of text represented in the digital ink stroke information, the temporal line grouping model being analyzing a sequence in which each ink stroke comprising the digital ink stroke information was input; and determining a layout of the handwritten text based at least in part on the information identifying lines of text output by the temporal line grouping model.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example computing environment in which the techniques disclosed herein for digital ink processing may be implemented.

FIG. 2A is a diagram showing additional features of the ink processing pipeline shown in FIG. 1.

FIG. 2B is a diagram showing an example implementation of the stroke classification pipeline that can be used to implement the stroke classification unit shown in FIG. 2A.

FIG. 2C is a diagram showing an example implementation of the writing analysis unit shown in FIG. 2A.

FIG. 2D is a diagram that shows an example of the probabilities that have been calculated for three strokes representing characters of handwriting.

FIG. 2E shows an example of the progression of sample handwriting from the line detection to the region detection to the paragraph/list detection stages.

FIG. 3A is a diagram showing an example implementation of the model compression unit shown in FIG. 1.

FIG. 3B shows an example machine learning pipeline that includes multiple machine learning models which may be utilized by the ink processing pipeline.

FIGS. 3C and 3D show an example implementation of the adaptive developer environment and how the adaptive developer environment can select a set of compressed models to be implemented on a resource-constrained device.

FIGS. 4A-4E are diagrams showing example of modifications that can be made to the architecture of the machine learning models by the model compression unit to enable these models to be implemented on a resource-constrained client device instead of the ink processing service.

FIG. 5 is a diagram showing additional details of the moderation services shown in FIG. 1.

FIG. 6A is an example flow chart of an example process for generating compressed versions of machine learning models that can be implemented on a resource-constrained device.

FIG. 6B is an example flow chart of another example process for generating compressed versions of machine learning models that can be implemented on a resource-constrained device.

FIG. 6C is an example flow chart of an example process for processing ink stroke information in an ink stroke pipeline according to the techniques described herein.

FIG. 7 is a block diagram showing an example software architecture, various portions of which may be used in conjunction with various hardware architectures herein described, which may implement any of the described features.

FIG. 8 is a block diagram showing components of an example machine configured to read instructions from a machine-readable medium and perform any of the features described herein.

### DETAILED DESCRIPTION

Techniques for compressing the architecture of a deep learning model are provided to enable execution of instances of the deep learning model on resource-constrained devices that lack the computing resources to execute an instance of the uncompressed model. These techniques can be used to compress one or more machine learning models, including one or more models used to perform digital ink processing to permit these models to operate on resource-constrained devices that would otherwise be unable to operate such models. The digital ink processing includes digital ink stroke classification, writing layout analysis, and/or other digital ink processing techniques that are implemented using machine learning models that are typically too resource intensive to be implemented on resource-constrained devices. Such devices typically have slowed or limited network connectivity that precludes these devices from relying on models implemented by cloud-based services, because the latency introduced by the network connectivity constraints would significantly degrade the user experience.

The techniques described herein can be used to implement models for analyzing ink stroke information locally on such resource-constrained devices and to select an appropriate combination of models to be implemented on the resource-constrained device. These models can be used to enable classification of ink stroke information as handwriting or drawings, determining the layout of handwriting, and other on-device services that would typically be implemented by a cloud-based service. Resource-constrained devices have slow or limited network connectivity and could not rely on such cloud-based services.

The techniques provided herein implement an adaptive developer environment for machine learning models that consider device information for resource-constrained devices on which the machine leaning models are to be utilized as well as performance requirements for the models to generate a set of compressed machine learning models appropriate for the resource-constrained device. The device information includes various information about the device, such as processor type of the device, the amount of memory in the device, the amount of storage in the device, and/or other information indicative of the capabilities of the resource-constrained device. The performance requirements include but are not limited to the sizes of the compressed models, measured latency of the compressed models, the measured memory consumption of the compressed models, and the accuracy of the compressed models. The adaptive developer environment provided herein utilizes various techniques to compress the machine learning models to satisfy the performance requirements to generate a combination of compressed models suitable for the hardware of a particular resource-constrained device.

The adaptive developer environment implements various techniques to alter the model architecture to compress the machine learning models to enable instances of these models to be implemented on a resource-constrained user device instead of a cloud-based service. In some implementations, the standard convolution layers of the model are replaced with depthwise separable convolution layers, which significantly decreases the number of floating-point operations performed by the convolution layer. The number of filters of the convolution layer is reduced, in some implementations, to further reduce the complexity of the model, thereby further reducing the computing and memory resources required to execute an instance of the model. The techniques herein further decrease the size of the model through quantization and graph optimization. Quantization refers to performing computations and storing tensors at a lower bit width than at floating point precision. Graph optimization is used to eliminate layers from the model that are only useful for training and by computing constant values preemptively. A technical benefit of this approach is that the size of the model can be substantially decreased without substantially decreasing the accuracy of the models. Consequently, the models can be implemented locally on user devices that would not otherwise have the processing and/or memory resources required to implement unmodified instances of the models.

The performance of the models is also improved through data augmentation in some implementations. Training data is selected that is similar to that which the model is likely to encounter when in use by end users. A technical benefit of data augmentation is the performance of the models can be improved to offsets potential slight decreases in accuracy of the models which may have resulted from compression of the models.

These techniques provided herein can offer an improved user experience for users of resource-constrained user devices that have limited network access and/or limited computing and/or memory resources without compromising the accuracy of the prediction of the models used to provide digital ink processing. While many of the examples which follow utilize the model compression techniques to models for classifying ink stroke data as handwriting or drawings, the techniques described here are not limited to these specific types of models. These techniques can be applied to compress deep learning models trained to provide other types of predictions to permit these models to be implemented locally on resource-constrained devices. These and other technical benefits of the techniques disclosed herein will be evident from the discussion of the example implementations that follow.

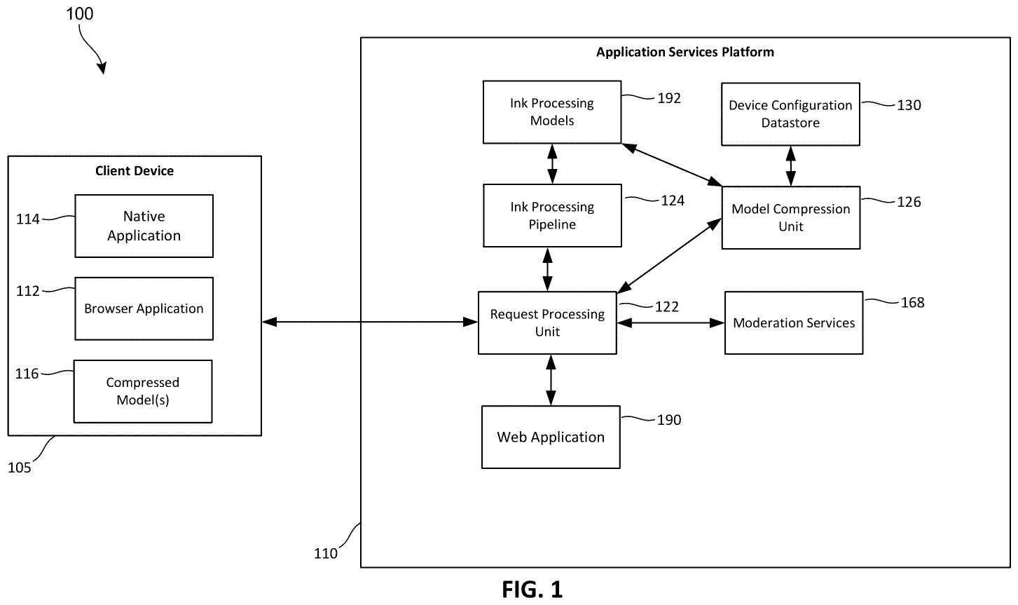

FIG. 1 is a diagram showing an example computing environment 100 in which the techniques disclosed herein for enabling on-device shape recognition for digital ink applications may be implemented. The computing environment 100 includes an application services platform 110. The example computing environment 100 also includes a client device 105. The client device 105 communicates with the application services platform 110 via a network (not shown). The network connection may be a combination of one or more public and/or private networks and may be implemented at least in part by the Internet.

In the example shown in FIG. 1, the application services platform 110 is implemented as a cloud-based service or set of services. The application services platform 110 analyzes digital ink information obtained from a web application 190 implemented on the application services platform 110 or from a native application 114 implemented on the client device 105. The application services platform 110 implements one or more machine learning models that analyze ink stroke data to support the various services provided by the application services platform 110. In some implementations, the application services platform 110 implements a stroke classification model trained to classify ink strokes as writing or a drawing and/or a writing layout analysis model trained to determine the layout of handwriting in a document. The application services platform 110 converts handwriting detected in the ink stroke data into text in some implementations. The application services platform 110 also identifies and convert hand drawn shapes into standardized representations of those shapes. In some implementations, the application services platform 110 implements a machine learning model trained to classify shapes in the ink stroke data. The application services platform 110 may provide other types of services associated with digital ink processing and may implement additional machine learning models to provide these services.

The request processing unit 122 is receives requests from the native application 114 of the client device 105 and/or the web application 190 of the application services platform 110. The requests may include but are not limited to requests to create, view, and/or modify various types of electronic content and/or to process ink stroke inputs provided by a user of the native application 114 or the web application 190 according to the techniques provided herein. The request processing unit 122 provides the input ink strokes received from the native application 114 or the web application 190 to the ink processing pipeline 124 for processing and receives a document tree representing the handwriting information, drawing information, and layout information from the ink processing pipeline 124, organized in a tree structured referred to herein as a document tree. The request processing unit 122 provides the document tree to the native application 114 or the web application 190 for processing. The native application 114 or the web application 190 generates a visualization of the contents of the document tree on a user interface of the native application 114 or the web application 190 in some implementations. The request processing unit 122 also coordinates communication and exchange of data among components of the application services platform 110 as discussed in the examples which follow.

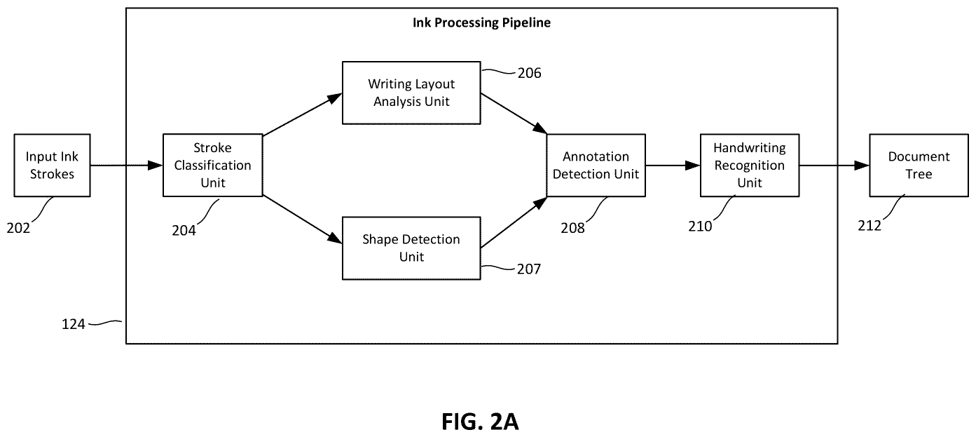

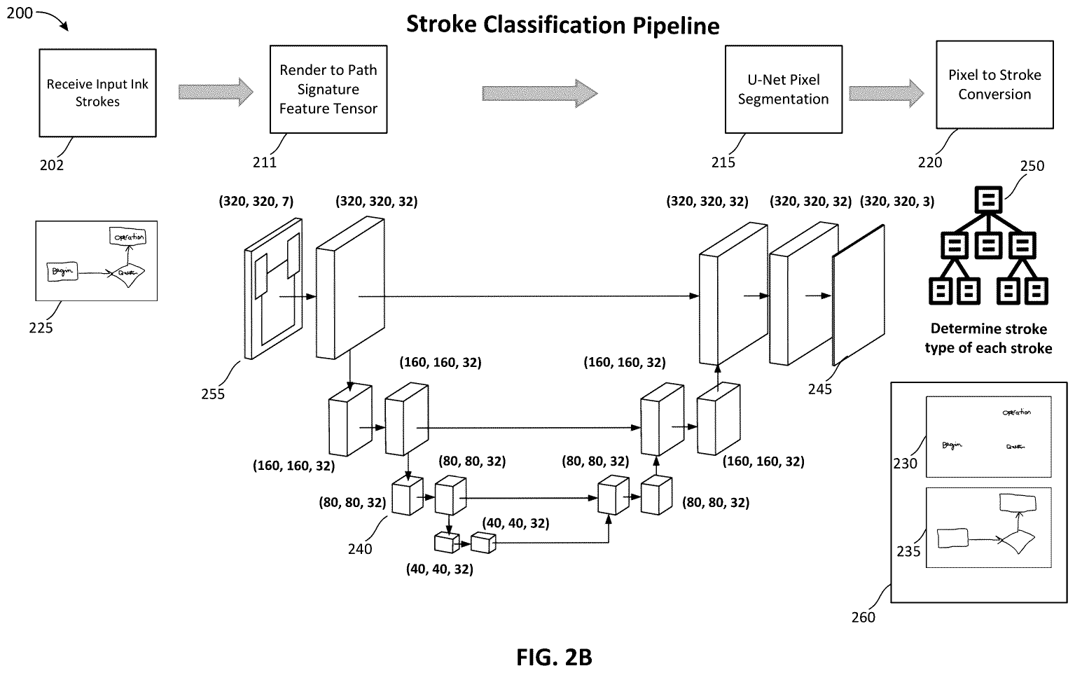

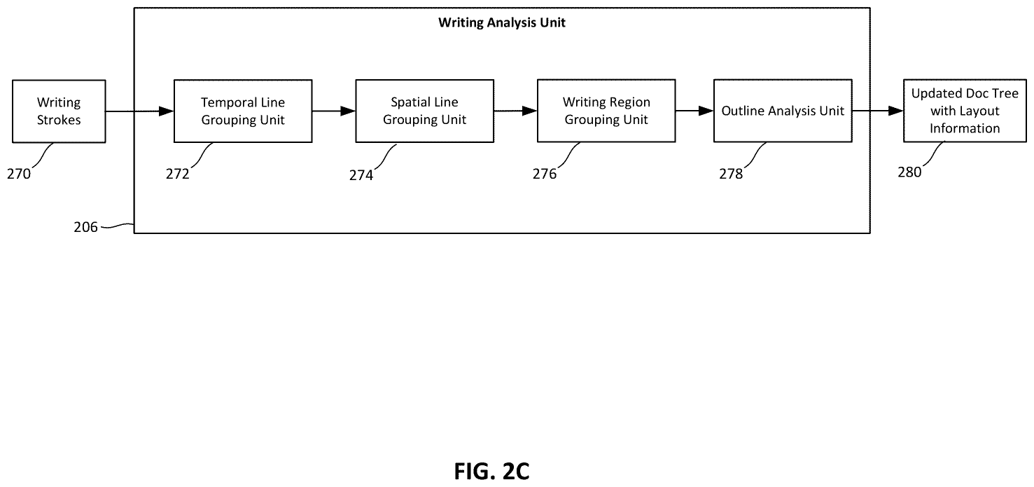

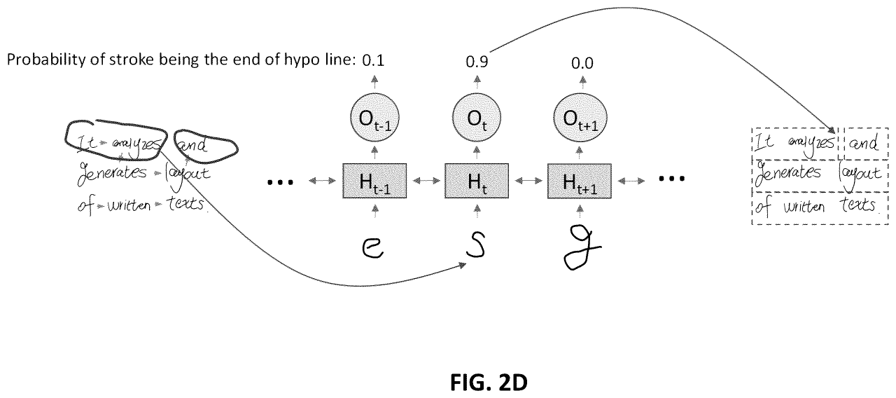

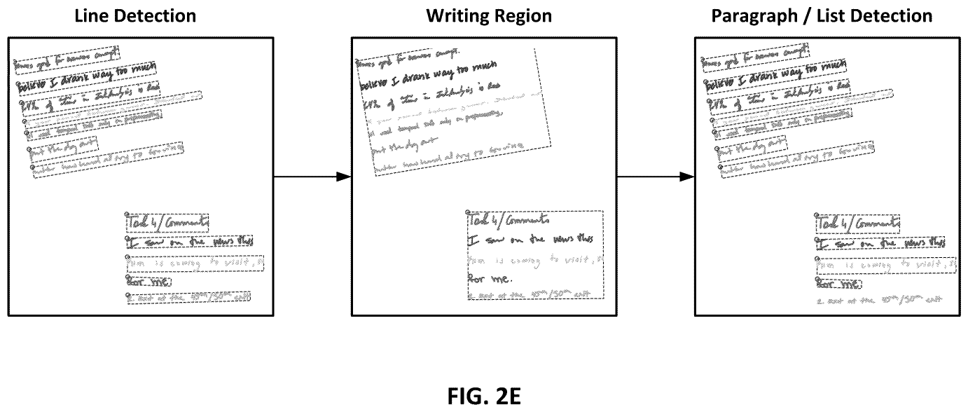

The ink processing pipeline 124 processes ink stroke information received by the native application 114 or the web application 190 and processes the ink stroke information using various machine learning models. The ink processing pipeline 124 performs stroke classification, determines the layout of writing, performs shape detection, and/or other processing on the ink stroke information. The ink processing pipeline 124 generates a representation of the handwriting, drawings, and layout information from the ink stroke information. The ink processing pipeline 124 uses the ink processing models 192 for processing the input ink stokes received from the native application 114 or the web application 190 as discussed in detail in the examples which follow. FIG. 2A provides an example implementation of the ink processing pipeline 124.

The device configuration datastore 130 is a persistent datastore that stores information about various types of devices, including resource-constrained devices, for which the various machine learning models utilized by the application services platform 110 can be compressed for use one these devices. The device configuration datastore 130 can be updated to include additional devices as new devices become available that can support local instances of the compressed machine learning models. The types of devices supported may vary from implementation to implementation.

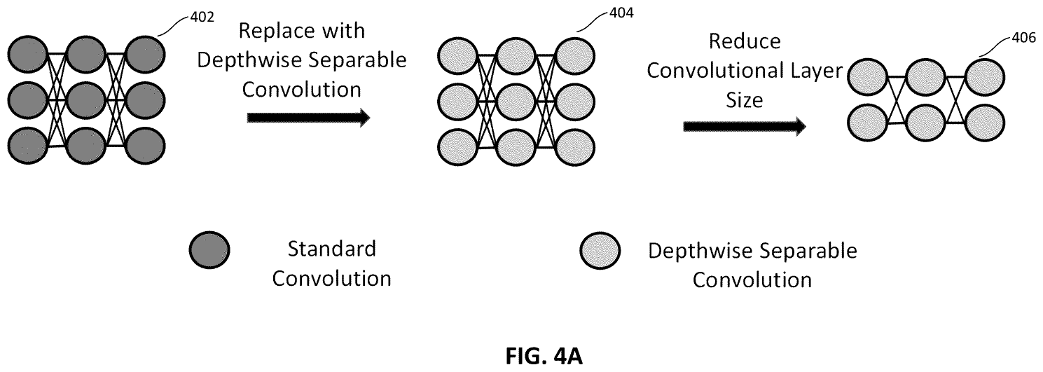

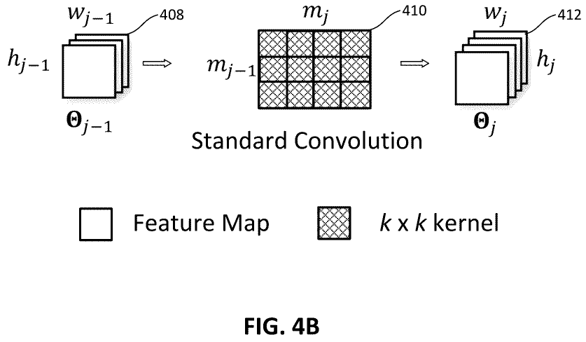

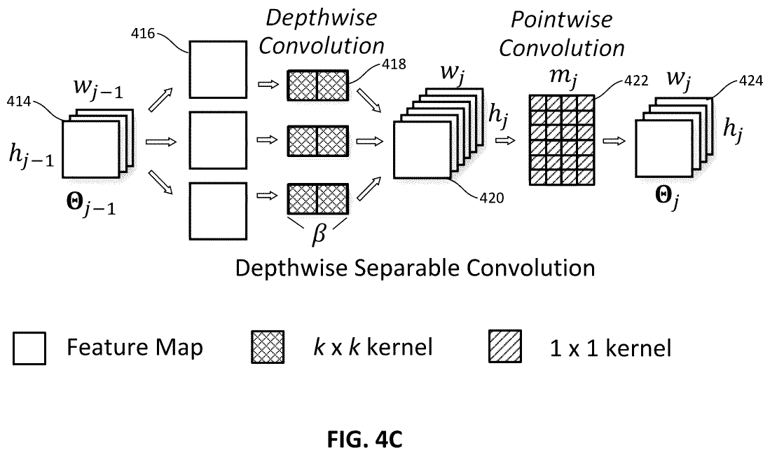

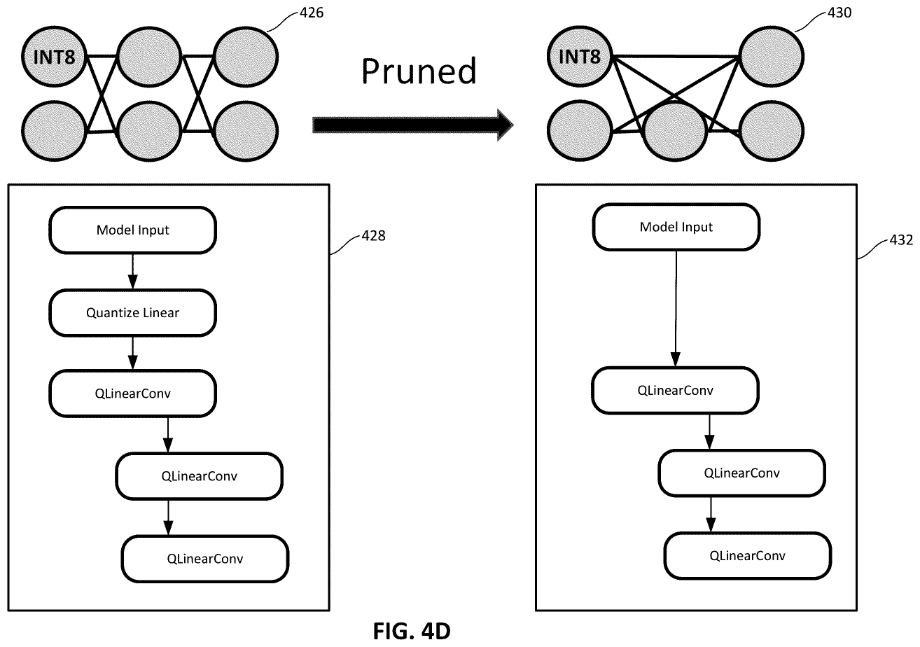

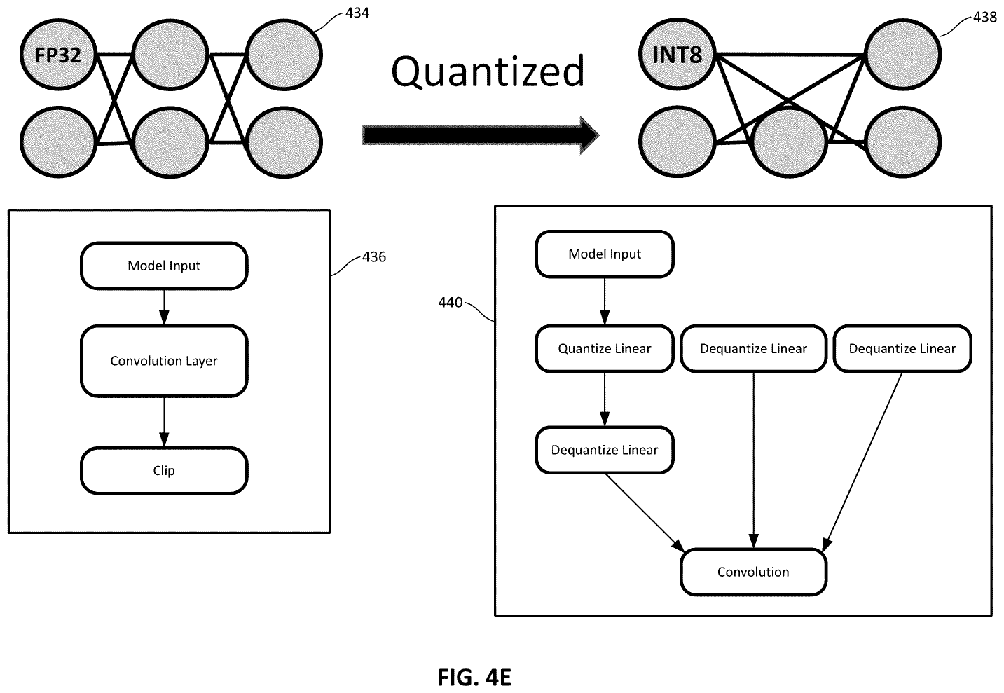

The model compression unit 126 obtains device information for a resource-constrained devices from the device configuration datastore 130 and generates compressed versions of the ink processing models 192 used by the ink processing pipeline 124 to enable the models to be implemented on the resource-constrained device. The model compression unit 126 receives a request from the client device 105 of an administrator to create compressed versions of one or more machine learning models via the request processing unit 122. The model compression unit 126 implements an adaptive developer environment for machine learning models that considers device information for resource-constrained devices on which the machine leaning models are to be utilized as well as performance requirements for the models to generate a set of compressed machine learning models appropriate for the resource-constrained device. The performance requirements include but are not limited to latency of the compressed models, the size of the compressed models, and the accuracy of the machine learning models. Additional details of the model compression unit 126 are shown in FIG. 4A, and examples of some of the compression techniques that can be implemented by the model compression unit 126 are shown in FIGS. 4B-4E.

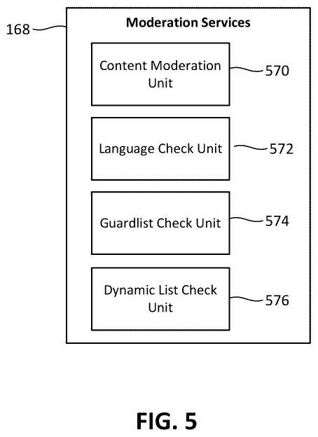

The moderation services 168 analyze textual content generated by the various machine learning models utilized by the ink processing pipeline 124 to ensure that neither the textual content generated by the models from the ink strokes input by a user do not contain potentially objectionable or offensive content. Additional details of the moderation services 168 are shown in the example implementation shown in FIG. 5.

The application service 110 may also provide cloud-based software and services that are accessible to users via the client device 105. The application service 110 provides one or more software applications, including but not limited to communications platform and/or collaboration platform, a word processing application, a presentation design application, and/or other types of applications in which the user may create and/or access electronic content. The electronic content may be stored on the application services platform 110 and/or the client device 105. The term “electronic content” as used herein can be representative of any document or component in electronic form that can be created by a computing device, stored in a machine-readable storage medium, and/or transferred among computing devices over a network connection or via a machine-readable storage medium. Examples of such electronic documents include but are not limited to word processing documents, program code, presentations, websites (e.g., Microsoft SharePoint® sites), digital drawings, media files, components thereof, and the like. The one or more software applications provided by the application services platform 110 receive ink stroke data from users via the client device 105 and utilize the application services platform 110 to process the received ink stroke data provided as input by user of the client device 105. The one or more applications permit the user to provide handwritten and/or drawn content, and the one or more applications may utilize the services provided by the application services platform 110 to analyze handwritten and/or drawn content. In some implementations, the applications may be provided by a separate application services platform (not shown) and the application services platform 110 provides ink processing services to the applications provided by the other application services platform.

The client device 105 is a computing device that may be implemented as a portable electronic device, such as a mobile phone, a tablet computer, a laptop computer, a portable digital assistant device, a portable game console, and/or other such devices. The client device 105 may also be implemented in computing devices having other form factors, such as a desktop computer, vehicle onboard computing system, a kiosk, a point-of-sale system, a video game console, and/or other types of computing devices. While the example implementation illustrated in FIG. 1 includes just one client device, other implementations may include a different number of client devices 105 that utilize the application services platform 110.

In other implementations, the application services platform 110, or at least a portion of the functionality thereof, is implemented by the native application 114 on the client device 105. In such implementations, the client device 105 can include the compress models 116, which are local instances of one or more of the machine learning models utilized by the application services platform 110 that have been compressed according to the techniques provided herein to enable the models to be utilized on resource constrained client device 105. The techniques provided herein can be used to reduce the size and complexity of the machine learning models to permit instance of the models to be implemented on the client device 105. The client device 105 may be a resource constrained device that has limited processing, memory, and/or storage capacity which would be unable to support an instance of the model or models that has not been reduced in size and/or complexity using the techniques provided herein. Furthermore, in some implementations, the client device 105 has limited network connectivity for accessing the services provided by the application services platform 110 and/or the application services platform 110. In such implementations, the client device 105 may implemented as a standalone device. In other implementation, the client device 105 may be unable to access the services provided by the application services platform 110 and/or the application services platform 110, or the limited network connectivity available to the client device 105 would introduce too much latency and the user experience would be significantly degraded. To address such network connectivity issues or lack of network connectivity in standalone device, instances of the machine learning models utilized by the application services platform 110 can be implemented on the client device 105. However, the size and complexity of the versions of the models implemented by the application services platform 110 would typically exceed the processing, memory, and storage resources of a resource-constrained device. Thus, the techniques provided herein can be used to implement instances of these models that utilize a modified architecture that is smaller and less complex and can be implemented locally on a resource-constrained client device 105. The one or more native applications 114 of the client device 105 utilize the local instances of the models rather than relying on the application services platform 110 to analyze ink stroke information. Details of how the model architecture is modified to permit the compressed model 116 to be implemented on such a resource-constrained device are described in the examples which follow.

The browser application 112 is an application for accessing and viewing web-based content, the web-based content may be provided by the application services platform 110. The application services platform 110 provides the web application 190 that enables users to consume, create, share, collaborate on, and/or modify content in some implementations. A user of the client device 105 may access the web application 190 via the browser application 112, and the browser application renders a user interface for interacting with the application services 110 in the browser application 112. The browser application 112 can be used to access the services provided by the application services platform 110 in implementations in which the client device 105 is not subjected to network connectivity constraints that would introduce latency that prevents the user from utilizing the ink processing services provided by the application services platform 110 or where such usage would utilize too much of data.

FIG. 2A is a diagram showing additional features of the ink processing pipeline 124 shown in FIG. 1. The ink processing pipeline 124 includes a stroke classification unit t204, a writing layout analysis unit 206, a shape detection unit 207, an annotation detection unit 208, and a handwriting recognition unit 210. The ink processing pipeline 124 receives the input ink strokes 202 obtained from the native application 114 or the web application 190 as an input from the request processing unit 122.

The stroke classification unit 204 analyzes the input ink strokes 202 using one or more machine learning models of the ink processing models 192 trained to distinguish between input ink strokes that are associated with handwriting from ink strokes that are associated with drawings. FIG. 2B shows an example implementation of the stroke classification unit 204. The stroke classification unit 204 provides information associated with the ink strokes classified as handwriting related strokes as an input to the writing layout analysis unit 206 and provides information with the ink strokes classified as shape related strokes to the shape detection unit 207. An example implementation of the stroke classification pipeline that can implement the classification unit 204 is shown in FIG. 2B.

The writing layout analysis unit 206 analyzes the handwriting related ink strokes to determine a layout for the handwriting. The handwriting may include one or more lines of text, and the lines of text may be organized into one or more writing regions and/or paragraphs of text. An example implementation of the writing layout analysis unit 206 is shown in FIG. 2C, which is discussed in detail in the examples which follow.

The shape detection unit 207 analyzes the shape related ink strokes to identify one or more shapes that the user has drawn. The shape detection unit 207 identifies and converts the hand drawn shapes into standardized representations of those shapes. The standardized representation of the shape is a formal representation of the shape that is predicted to have been drawn by the user. The formalized representation provides a cleaner appearance that the hand drawn shape input by the user. The shape detection unit 207 utilizes a shape-detection model of the ink processing models 192 to classify the shape drawn by the user. The shape detection unit 207 uses this classification information and the sizing information determined from the ink strokes associated with the shape to determine a size of the geometric object represented by the standardized shape, a line width for the geometric object, a line color for the geometric object, and/or other attributes of the geometric object. The shape detection unit 207 outputs the attributes of the standardized representation of the shape to the annotation detection unit 208.

The annotation detection unit 208 receives the writing layout information output by the writing layout analysis unit 206 and the shape information output by the shape detection unit 207 and combines this information into a combined layout that includes both the shapes and the handwriting.

The handwriting recognition unit 210 receives the output from the annotation detection unit 208 and generates the document tree 212 that represents a layout of the document that includes the handwriting, shapes, and layout information. The handwriting recognition unit converts the handwriting included in the input ink strokes 202 to text to include in the document tree 212. The input ink strokes 202 may be associated with an existing document to which the user has added the ink strokes. In such instances, the document tree 212 for the document has already been created and the handwriting recognition unit 210 updates the existing document tree 212 with the additional handwriting information.

FIG. 2B shows an example implementation of various elements of a stroke classification pipeline 200 that may be implemented by the application services platform 110. The stroke classification pipeline 200 includes multiple stages or operations, including an input stroke data operation 202, a render to path signature feature tensor operation 211, a U-Net pixel segmentation operation 215, and a pixel to stroke conversion operation 220. The stroke classification pipeline 200 can be implemented as software, hardware, or a combination thereof by the application services platform 110. The application services platform 110 utilizes one or more of the models of the ink processing model 192 to analyze the input ink strokes 202. The example shown in FIG. 2B is implemented using a U-Net architecture 340 which is a type of convolutional neural network (CNN).

The stroke classification pipeline 200 receives input stroke data 202 which represents handwritten text and/or hand drawn drawings as shown in FIG. 2A. The stroke classification pipeline 200 predicts whether a particular ink stroke is a drawing stroke or a writing stroke. The predictions provided by the stroke classification pipeline 200 are used to identify the drawing stroke data 235 and the handwriting stroke data 230 included in the example input stroke data 225. The handwriting stroke data 235 is provided as an input to the writing layout analysis unit 206 to identify the layout of the handwriting included therein, and the drawing stroke data 230 is provided as an input to the shape detection unit 207 to detect various shapes and/or objects included therein.

In operation 205, the stroke classification pipeline 200 receives the input stroke data 202 that represents handwritten text and/or hand drawn drawings. The input stroke data 202 may be captured using a touch screen, touch screen, drawing tablet, mouse, stylus, and/or another user interface element. The input stroke data 202 may be received as an image data file in various formats. The image data file may represent input stroke data as a 2D array of pixels that represent the input stroke data 202. In the example shown in FIG. 2B, the input stroke data 202 is represented by a 320-pixel by 320-pixel array of pixel data. The input stroke data may be preprocessed by the stroke classification pipeline 200 to resize the input stroke data to size that the components which follow expect to receive.

In operation 211, the input stroke data 202 is processed to render a path signature feature (PSF) tensor 255 that is provided as an input to a U-Net 240 for processing. The U-Net 240 is a modified convolutional neural network that was developed for biomedical image segmentation and provides fast and precise segmentation of images. The U-Net 240 used by the stroke classification pipeline 200 may be trained using training data that includes examples of handwritten text and/or drawings. The text and drawings may be intermingled in the training data because such intermingling of textual and drawing elements may be encountered in examples to be analyzed by the stroke classification pipeline 200. FIG. 2B shows an example of a simple diagram in which text and drawing elements are intermingled. Training data is used to train the U-Net 240 to provide a semantic determination for each pixel of input stroke data 202. U-Net 240 provides a technical benefit of requiring fewer training images to train the network and to yield more precise segmentations that a typical fully convolutional network. In the example shown in FIG. 2B, the U-Net 240 makes a prediction for each pixel of the input stroke data 202 whether that pixel is associated with a stroke that is a writing stroke. The stroke classification pipeline 200 infers which strokes of the input stroke data 202 are drawing strokes.

The PSF tensor 255 includes feature information extracted from the input stroke image data 225. The PSF tensor 255 includes the features extracted from the input stroke image data 225. The PSF tensor 255 includes information that describes the input stroke data 202 to permit the U-Net 240 to segment the input stroke data 202. In a non-limiting example, the tensor includes seven elements. The PSF tensor 255 includes 0-th order path signature features, which describe the geometrical location of the ink strokes that make up the input stroke data 202. The PSF tensor 255 also includes 1st order path signature features, which describe the geometrical translation of the stroke points that make up the input stroke data 202. The PSF tensor 255 also includes 2nd order path signature features, which describe curvature information for the ink path signatures.

In operation 215, the PSF tensor 255 is provided as an input to the U-Net 240 and the U-Net 240 outputs a pixel segmentation map 245. The U-Net 240 outputs the pixel segmentation map 245, which includes a prediction whether each pixel (also referred to herein as “stroke points”) included therein are a drawing pixel or a handwriting pixel. In operation 220, the pixel segmentation map 245 is analyzed using a pixel to stroke conversion (PSC) model 250 to further improve the accuracy of the predictions output by the U-Net 240. The PSC model 250 may be implemented by one of the ink processing models 192. The PSC model 250 uses the pixel-wise results from the U-Net 240 to recreate the strokes of the input stroke data 202. The output 260 from the PSC model 250 provides a final determination of the type of each of the strokes of the input stroke data 202. For example, the PSC model 250 may make a final determination of whether a particular stroke is a handwriting stroke or a drawing stroke and may include the drawing stroke data 230 and the writing stroke data 235. The PSC model 250 is implemented using a Gradient Boosting Tree (GBT) in some implementations.

FIG. 2C is a diagram showing an example implementation of the writing analysis unit 206 shown in FIG. 2A. The writing analysis unit 206 analyzes the ink stroke data to identify the layout of the handwriting included therein. The writing analysis unit 206 utilizes various techniques, including temporal line grouping and spatial line grouping techniques, to identify lines of handwriting. The writing analysis unit 206 then groups those lines of handwriting into writing regions, paragraphs, lists, and/or other groupings based on the layout of the lines relative one another and a semantic analysis of the lines of handwriting to predict text that is likely to be belong in the same grouping.

The writing analysis unit 206 includes a temporal line grouping unit 272, a spatial line grouping unit 274, a writing region grouping unit 276, and an outline analysis unit 278. The writing analysis unit 206 receives the writing stroke data 270 output by the stroke classification unit 204 and outputs an updated document tree with layout information 280. The document tree 280 is a tree structure that includes the text, drawings, and layout information for the handwriting and drawings input digital ink. The writing analysis unit 206 determines how the handwriting input by the user is laid out on the drawing canvas provided by the native application 114 or the web application 190. The writing analysis unit 206 groups handwriting into lines, writing regions, and paragraphs. A line refers to one or more words related to each other based on visual proximity and semantics. A writing region is grouping of writing lines having similar orientation and related to each other by semantics. A paragraph includes one or more lines that include one or more words. The paragraphs differ from each other based on their layouts and semantics. The semantics of the handwriting can be determined by submitting the text of the handwriting to a language model of the ink processing models 192.

The temporal line grouping unit 272 groups ink strokes into lines based on an order in which the ink strokes are input. The temporal line grouping unit 272 utilizes a Gated Recurrent Unit (GRU)-based recurrent neural network (RNN) to analyze the writing strokes 270 in some implementations. The output of the GRU provides probability values for each timestamp indicates a probability of the current stroke being an end of a line. FIG. 2D is a diagram that shows an example of the probabilities that have been calculated for three strokes representing characters of handwriting. A higher probability represents a higher likelihood that the ink stroke represents and end of a line of the handwriting. In the example shown in FIG. 2D, the probabilities indicate that the character “s” is likely to represent an end of a line of handwriting.

The spatial line grouping unit 274 identifies lines of the textual content based on the spatial location of the ink strokes. The spatial line grouping unit 274 groups the ink strokes into lines based on their spatial relationship to each other. The spatial line grouping unit 272 utilizes a GRU-based RNN in some implementations. In other implementations, the spatial line grouping unit 272 utilize another type of model. As can be seen in FIG. 2E, the lines of text can be angled and do have to be completely horizontal for the spatial line grouping unit 274 to identify the line groupings. The line grouping information from the temporal line grouping unit 272 and the spatial line grouping unit 274 are combined to provide the line grouping information for the document.

The writing region grouping unit 276 groups the lines detected by the temporal line grouping unit 272 and the spatial line grouping unit 274 into writing regions. Each region includes lines that have a similar orientation and are related to each other semantically. The region information output by the writing region grouping unit 276 is provided as an input to the outline analysis unit 278.

The outline analysis unit 278 analyzes the writing region information to identify paragraphs, lists, or other groupings of lines. The paragraphs differ from each other semantically and based on layout. FIG. 2E shows an example of the progression of sample handwriting from the line detection to the region detection to the paragraph/list detection stages. The various models utilized by the writing analysis unit 206 can be compressed using the techniques described herein to enable these models to be implemented on resource-constrained devices that would otherwise be unable to implement uncompressed version of these models. A typical RNN model would be too large to implement on a resource-constrained device. However, the techniques herein can be utilized to compress such models to permit the models to be implemented on such resource-constrained devices while satisfying performance requirements related to model speed, size, and/or accuracy.

In a non-limiting example implementation, the GRU-based RNN utilized by the temporal line grouping unit 272 and/or other elements of the writing analysis unit 206 has 4 layers with 32 hidden units per layer. In this non-limiting example implementation, there are 131 input features that include 64 ink points (each with x and y coordinates) and pen-up x and y coordinates, and the length of the current ink stroke at pen up. The techniques herein can be used to compress the model by varying the number of layers and/or the number of hidden units per layer and/or by varying the number of inputs. Other techniques discussed herein may also be used to compress the models to enable the models to be implemented on a resource-constrained device which satisfying the performance requirements for such implementations.

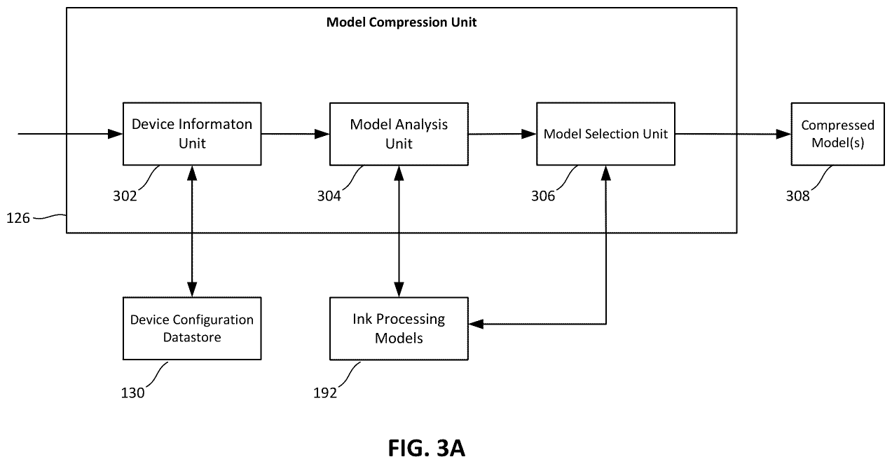

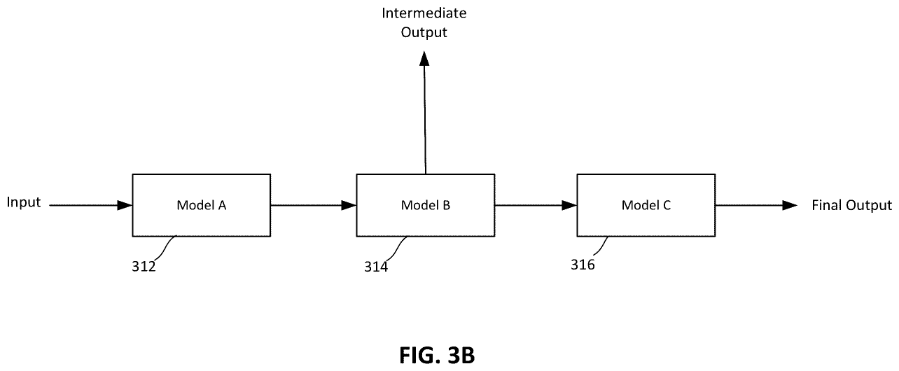

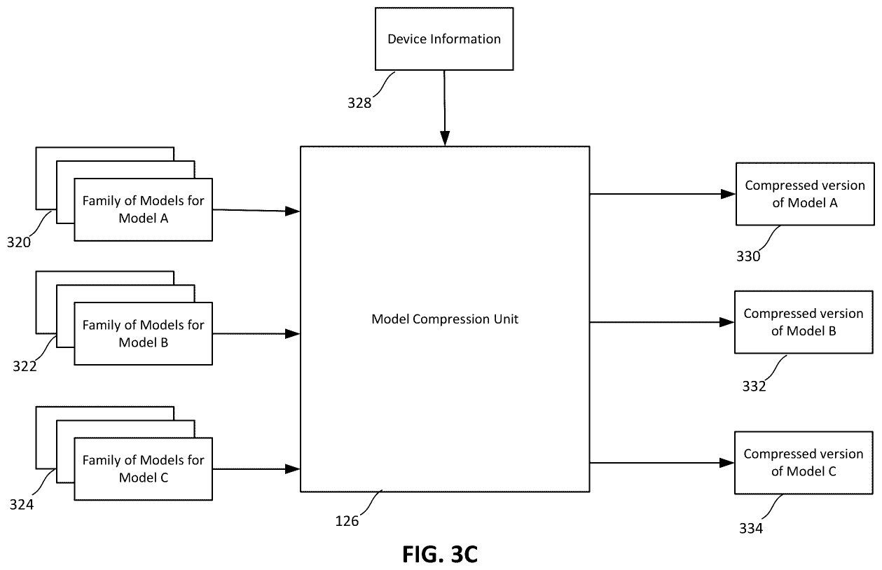

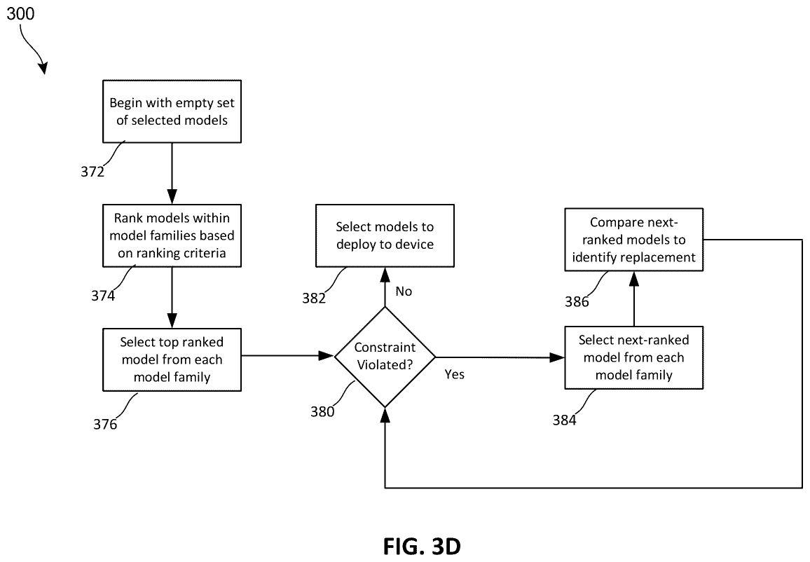

FIG. 3A is an example implementation of the model compression unit 126. The model compression unit 126 implements an adaptive developer environment that creates compressed version of machine learning models of the ink processing models 192 to be implemented on resource constrained devices. The model compression unit 126 includes a device information unit 302, a model analysis unit 304, and a model selection unit 306.

The device information unit 302 receives a request to create compressed versions of the machine learning models of the ink processing models 192 to be implemented on a particular resource-constrained device. The request is received by the request processing unit 122 from the client device 105 of an administrator or other user authorized to generate compressed versions of the machine learning models for a resource-constrained device. The request processing unit 122 provides the request to the model compression unit 126. The request includes an indication of the device type for which the compressed machine learning models are to be generated. The device information unit 302 accesses the device configuration datastore 130 to obtain the device information for the resource-constrained device. The device information includes various information about the device, such as processor type of the device, the amount of memory in the device, the amount of storage in the device, and/or other information indicative of the capabilities of the resource-constrained device. The device information unit 302 provides the device information to the model analysis unit 304.

The model analysis unit 304 receives the device information from the device information unit 302 and accesses the ink processing models 192 to obtain information about the machine learning models to be compressed by the model selection unit 306. In some implementations, the model analysis unit 304 utilizes the process shown in FIG. 3D to select the models to be deployed to the resource-constrained device. The model analysis unit 304 provides a list of compressed models to be deployed to the resource-constrained device to the model selection unit 306 determines whether the selected versions of the compressed models to be deployed to the resource-constrained device are available in the ink processing models 192. If the selected versions of the compressed models have not yet been generated, the model selection unit 306 using one or more of the techniques shown in FIGS. 4A-4E to generate the compressed versions of the models. The model selection unit 306 stores the compressed version of the models with the ink processing models 192 if not already available on application services platform 110. The selected compressed models are then installed on the resource-constrained computing device. The selected models may be deployed to other resource-constrained computing devices of the same type as the resource-constrained computing device.

FIGS. 4A-4E are diagrams showing example of modifications that can be made to the architecture of the machine learning models of the ink processing models 192 to permit instances of the models to be implemented locally on a resource-constrained client device 105. In some implementations, one or more of the techniques shown in FIGS. 4A-4E are used to reduce the size and complexity of the models to permit the models to be implemented on a resource-constrained client device 105.

FIG. 3B shows an example machine learning pipeline that includes multiple machine learning models 312, 314, and 316 which may be utilized by the ink processing pipeline 124. The specific models and sequence in which the models are utilized can vary depending upon the specific implementation and the functionality. In the example implementation shown in FIG. 3B, the model 312 performs a first actions on the input ink strokes, the model 314 performs second actions on the output from the model 312 and outputs an intermediate output that may be presented to the user and/or further processed by one or more other components of the application services platform 110. The intermediate result is also provided as an input to the model 316. The model 316 performs third actions on the intermediate output and outputs a final output. The models 312, 314, and 316 are the non-compressed models that are implemented on the application services platform 110 and used by the ink processing pipeline 124. FIGS. 3C and 3D show an example of how the models can be compressed for use on a resource-constrained device.

FIGS. 3C and 3D show an example implementation of the model compression unit 126 and how the model compression unit 126 can select a set of compressed models to be implemented on a resource-constrained device. The model compression unit 126 can be implemented by the ink processing pipeline 124 shown in the preceding examples. Each of the models 312, 314, and 316 utilized by the example implementation of the ink processing pipeline 124 shown in FIG. 3B may be compressed various techniques to create a family of models 320, 322, and 324 which include the original uncompressed model and a set of instances of the original uncompressed model that have been compressed using various techniques. The compressed models can be compressed to adjust the size of the model, the measured latency associated with an instance of the model, the measured memory consumption associated with an instance of the model, the accuracy of the instance of the model, and/or other attributes of the model. Each of the instances included in a family of models has different attributes that that include specific model size, measure latency, measured memory consumption, and/or accuracy requirements that satisfy the specific requirements for the performance of the compressed model on a resource-constrained device. The instances of the models included in a particular family of models may be created preemptively and added to the ink processing models 192 or may be created in response to the specific performance requirements of one or more resource-constrained devices. In the example shown in FIG. 3C, the families of models 320, 322, and 324 have already been created, and the model compression unit 126 facilitates the selection of an appropriate set of models for a particular resource-constrained device based on the device information 328. The device information 328 includes various information about the device, such as processor type of the device, the amount of memory in the device, the amount of storage in the device, and/or other information indicative of the capabilities of the resource-constrained device. The model compression unit 126 also considers performance requirements when selecting which compressed models to select from among the family of models. The performance requirements include but are not limited to the sizes of the compressed models, measured latency of the compressed models, the measured memory consumption of the compressed models, and the accuracy of the compressed models. The performance requirements may be expressed as a range of acceptable values for each of these attributes of the performance requirements. The model compression unit 126 selects appropriate compressed versions 330, 332, and 334 from each of the families of models based on the constraints associated with the performance requirements for implementing the compressed models on the resource-constrained device.

FIG. 3D is an example process 300 for selecting models to be implemented on a resource-constrained device from families of models. The process shown in FIG. 3D can be implemented by the model analysis unit 304 discussed in the preceding examples to select which implementations of the machine learning models to implement on a resource-constrained device based on the device information and performance requirements for the models on that resource-constrained device.

The process 300 includes an operation 372 in which an empty set of models to be implemented on the resource-constrained device is instantiated. The process 300 includes an operation 372 of ranking the machine learning models within each of the model families based on ranking criteria. As discussed with respect to FIG. 3C, the ink processing pipeline 124 can utilize more than one type of machine learning model of the ink processing models 192 and these models are grouped into families of models. The models are ranked within each family based on ranking criteria. The ranking criteria can include one or more of model accuracy, model size, model memory consumption, model latency, and/or other performance attributes of the models. In operation 376, the top-ranked model from each of the families of models is selected. In operation 380, a determination is made whether the selected models violate one or more constraints associated with the performance requirements. If no constraints were violated, then the process 300 continues with operation 382 in which the selected models from each of the families of models are deployed to the resource-constrained device. Otherwise, if a constraint was violated, the process 300 continues with operation 384 in which a next-ranked model from each of the model families 384 is selected. In operation 386 the next-ranked models selected in operation 384 are compared with the performance requirements, and the process 300 returns to operation 380 to determine whether the next-ranked models violate any constraints associated with the performance requirements. The process 300 continues until a set of models is selected or until no set of models satisfies the performance requirements.

FIG. 4A shows an example of one of these modifications in which the standard convolution layer 402 of a CNN model is replaced with a depthwise separable convolution layer 404. In some implementations, an architecture similar to that of the MobileNetV2 architecture is used to implement the depthwise separable convolution layer 404. The MobileNetV2 architecture was developed to provide highly accurate deep neural networks to smartphones and other such resource-constrained devices. Depthwise spatial convolution is an alternate approach to standard convolution in which a spatial convolution is performed followed by depthwise convolution. A technical benefit of this approach is that depthwise spatial conversion decouples the spatial and depthwise information, which in turn reduces the complexity and number of floating-point calculations that are performed by the convolution layer.

FIG. 4A also shows that the architecture of the model can be further modified to reduce complexity by reducing the size of the convolutional layer to produce a smaller convolutional layer 406. The width of the convolutional layer is reduced by eliminating filters from the convolutional layer. The reduction in the width of the model can be determined during the training process. Instance of the model having a smaller convolutional layer can be tested to determine whether the accuracy of the model satisfies at least a threshold accuracy until a minimum size for the convolutional layer is determined that still satisfies the threshold accuracy. A technical benefit of this approach is that the complexity of the convolutional layer is reduced, which further reduces the computing, memory, and storage resources required to implement the model on a resource-constrained model.

FIG. 4B shows an example configuration of a standard convolution layer 410. The input of the standard convolution layer 410 is a feature map 408 that may be extracted from an input to the neural network or is the output of another convolutional layer of the neural network. The standard convolution layer 410 utilizes a k×k kernel 310 that performs convolution on the input feature map 408 to extract the feature map 412.

FIG. 4C shows an example configuration of a depthwise separable convolution layer in which the depthwise convolution 418 and the pointwise convolution 422 have been implemented as separate layers. The input 414 and the output 424 are of the same size as the input 408 and the output 412 of the standard convolutional layer implementation shown in FIG. 4B, but the complexity of the floating-point computations to be performed by the separable convolution layer shown in FIG. 4B are significantly less complex that those performed in the standard convolution layer. In the separable convolution layer, the input 414 is divided by channel into a plurality of channel-specific inputs 416. Therefore, each of the j channels will have a separate input into a respective one of the j filters 418 perform the convolution at the depthwise convolution layer. The features 420 output by the depthwise convolution layer include a set of features extracted by each of the j filters of the depthwise convolution layer. The features 420 are provided as an input to the pointwise convolution layer 422, which implements a 1×1 kernel. The pointwise convolutional layer convolves the features 420 to generate the features 424. A technical benefit of the depthwise separable convolution approach shown in FIG. 4C is that this approach reduces the number of floating-point calculations performed by approximately tenfold compared with the standard convolution approach shown in FIG. 4B. Consequently, the processing, memory, and storage resources required to implement such a model on a client device 105 are significantly reduced, which can help ensure that the model can be implemented on resource-constrained client devices that would otherwise lack the computing resources to implement a model that implements standard convolution, such as that shown in FIG. 4B.

FIG. 4D is a diagram showing a model pruning technique that can be used to further alter the architecture of the machine learning model to compress instances of the model to be implemented locally on a resource-constrained client device 105. In the example shown in FIG. 4D, the convolution layer 426 is shown with a corresponding graph 428 which represents the model. In some implementations, the model can be optimized by removing layers that are useful for training the model, such as but not limited to the identity layer and the dropout layer but are not useful once the model has been trained. These layers can be removed as shown in the modified graph 432 to generate a simplified version of the convolutional layer 430. The model pruning technique can also implement constant folding, in which constant values are computed preemptively rather than at runtime. A technical benefit of the model pruning techniques is that the processing, memory, and storage resources required to implement such a model on a client device 105 are significantly reduced, which can help ensure that the model can be implemented on resource-constrained client devices that would otherwise lack the computing resources to implement the model.

FIG. 4E is a diagram showing a model quantization technique that can be used to further alter the architecture of the machine learning model to compress instances of the model to be implemented locally on a resource-constrained client device 105. Quantization refers to techniques for performing computations and storing the model tensors at lower bitwidths than floating point precision that would typically be used in a standard implementation of a CNN or such machine learning model. The quantized model executes some or all mathematical operations on tensors using integers rather than floating point values. A technical benefit of this approach is that quantization provides a more compact model representation. In some implementations, 32-bit floating point (FP32) values are quantized to 8-bit integer (INT8) values to reduce the size of the numerical values of the model to one fourth of the bitwidth of the unquantized model.

In some implementations, the architecture of the model is modified to support the quantization by including additional layers that convert floating-point inputs to integer values, perform the matrix operations using the integer values, and convert the integer values output by the quantized convolution layer to floating-point values. A technical benefit of this approach is that the quantized convolution layer can receive the same floating-point inputs that would be received by a standard convolutional layer and outputs a similar floating-point output as the standard convolutional model. In the example shown in FIG. 4E, the pre-quantized convolution layer 434 is represented, in part, by the graph 436, and the quantized convolution layer 438 is represented, in part, by the graph 440. The graph 440 includes four layers that replace the conventional convolution layer of the graph 436. In this example implementation, these layers include a quantization layer for quantizing the input from a floating-point value to an integer value, a dequantization layer for de-quantizing the integer output, a dequantization layer for the bias (b) of the convolutional layer, and a dequantization layer for the weight (W) of the dequantization layer. Other implementations may include a different number of layers to implement the quantization.

The performance of the compressed models can also be improved through data augmentation. Data augmentation is used to generate training data that is similar to the types of data the model is likely to encounter when in use by end users. In instances where the model being trained is a shape-classification model, the training data may be augmented to include multiple variations of sample hand drawn shapes. These samples may be flipped horizontally or vertically, rotated, and/or have perspective distortion applied to create more relevant training data for training the model. A technical benefit of data augmentation is the performance of the models can be improved to offsets the slight decreases in accuracy of the models resulting from compression of the models. The augmented training data is used to train the uncompressed version of the model in some implementations, and the compressed version of the model derived from the uncompressed version of the model also benefits from the improvement in accuracy resulting from the data augmentation.

FIG. 5 is a diagram showing additional details of the moderation services shown in FIG. 1. The moderation services 168 analyze textual content generated by the various machine learning models utilized by the ink processing pipeline 124 to ensure that neither the textual content generated by the models from the ink strokes input by a user do not contain potentially objectionable or offensive content. If potentially objectionable or offensive content is detected, the moderation services 168 provides a blocked content notification to the client device 105 indicating that the handwriting input using ink strokes includes potentially objectionable or offensive content.

The moderation services 168 performs several types of checks on the textual content extracted from the handwriting. The content moderation unit 570 is implemented by a machine learning model trained to analyze the textual content of these various inputs to perform a semantic analysis on the textual content to predict whether the content includes potentially objectionable or offensive content. The language check unit 572 performs another check on the textual content using a second model that analyzes the words and/or phrase used in textual content to identify potentially offensive language. The guard list check unit 574 is compares the language used in the textual content with a list of prohibited terms including known offensive words and/or phrases. The dynamic list check unit 576 provides a dynamic list that can be quickly updated by administrators to add additional prohibited words and/or phrases. The dynamic list may be updated to address problems such as words or phrases becoming offensive that were not previously deemed to be offensive. The words and/or phrases added to the dynamic list may be periodically migrated to the guard list as the guard list is updated. The specific checks performed by the moderation services 168 may vary from implementation to implementation. If one or more of these checks determines that the textual content derived from the handwriting includes offensive content, the moderation services 168 can notify the application services platform 110 that some action should be taken.

In some implementations, the moderation services 168 generates a blocked content notification, which is provided to the client device 105. The native application 114 or the web application 190 receives the notification and presents a message on a user interface of the application that the ink strokes received by the request processing unit 122 could not be processed. The user interface provides information indicating why the blocked content notification was issued in some implementations. The user may attempt to refine the ink strokes input to remove the potentially offensive content. A technical benefit of this approach is that the moderation services 168 provides safeguards against both user-created and model-created content to ensure that prohibited offensive or potentially offensive content is not presented to the user in the native application 114 or the web application 190.

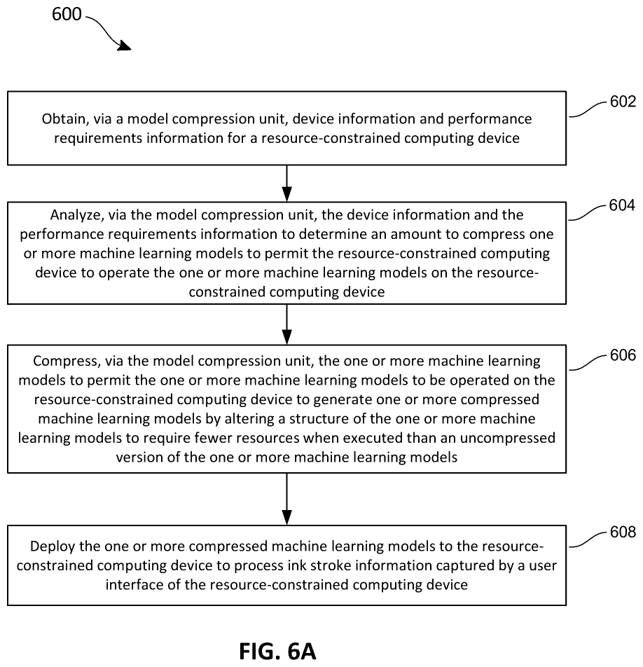

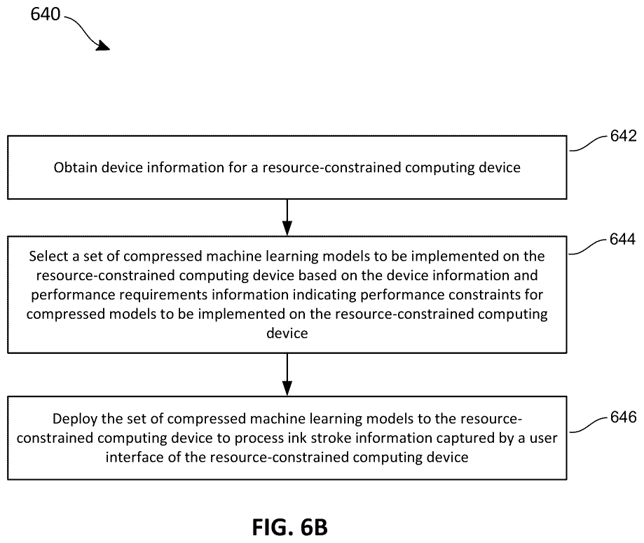

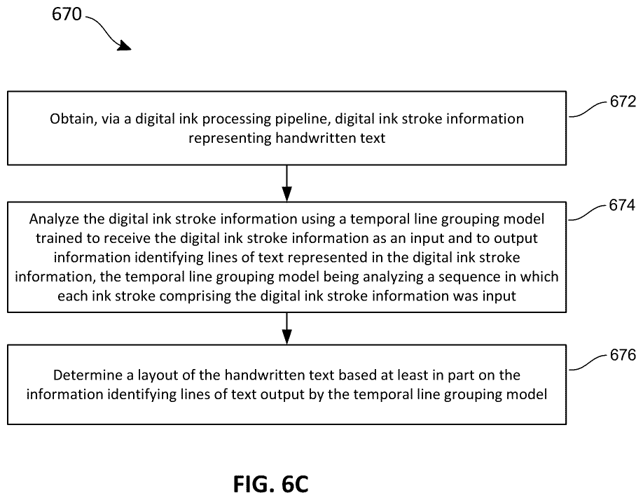

FIG. 6A is an example flow chart of an example process 600 for generating compressed versions of machine learning models that can be implemented on a resource-constrained device, such as the client device 105.

The process 600 includes an operation 602 of obtaining, via a model compression unit, device information for a resource-constrained computing device. The device information is stored in the device configuration datastore 130 in some implementations. An administrator or other authorized user may update the device configuration datastore 130 to add information for additional devices, modify information for existing devices, and/or remove the information for devices that are no longer supported. The performance information is also stored in the device configuration datastore 130. The model compression unit 126 receives the device information and the performance requirements information for the resource constrained device. The device information may include processor type information, device memory information, device storage information, and/or other information about the resource-constrained device, and the performance requirements information may include model latency requirements, model size requirements, model accuracy requirements, and/or other performance requirements for the models on the resource-constrained device.

The process 600 includes an operation 604 of analyzing, via the model compression unit, the device information and the performance requirements information to determine an amount to compress one or more machine learning models to permit the resource-constrained computing device to operate the one or more machine learning models on the resource-constrained computing device. The one or more machine learning models include a stroke classification model for classifying digital ink stroke information as handwriting or a drawing in some implementations.

The process 600 includes an operation 606 of compressing the one or more machine learning models to permit the one or more machine learning models to operate on the resource-constrained computing device to generate one or more compressed machine learning models by altering the structure of the one or more machine learning models to require fewer resources when executed than an uncompressed version of the one or more machine learning models. As discussed in the preceding examples, the model compression unit 126 can generate the compressed machine learning models using various techniques to alter the structure of the machine learning models, such as but not limited to those shown in FIGS. 4A-4E.

The process 600 includes an operation 608 of deploying the one or more compressed machine learning models to the resource-constrained computing device to process ink stroke information captured by a user interface of the resource-constrained computing device. The models selected by the model compression unit 126 are installed on and executed by the resource-constrained computing device to provide ink stroke analysis services that would otherwise be implemented on the application services platform 110.

FIG. 6B is an example flow chart of an example process 640 for operating an instance of a compressed machine learning model on a resource-constrained device. The process 640 can be implemented by the application services platform 110 described herein.

The process 640 includes an operation 642 of obtaining device information for a resource-constrained computing device. The device information is stored in the device configuration datastore 130 in some implementations. An administrator or other authorized user may update the device configuration datastore 130 to add information for additional devices, modify information for existing devices, and/or remove the information for devices that are no longer supported.

The process 640 includes an operation 644 of selecting a set of compressed machine learning models to be implemented on the resource-constrained computing device based on the device information and performance requirements information indicating performance constraints for compressed models to be implemented on the resource-constrained computing device. The model compression unit 126 analyzes the device information and performance requirements to select a set of models from among the families of models for each of the models. The model compression unit 126 generates the selected versions of the compressed models according to the techniques provided herein if one or more of the selected versions are not included in the ink processing models 192.

The process 640 includes an operation 646 of deploying the set of compressed machine learning models to the resource-constrained computing device to process ink stroke information captured by a user interface of the resource-constrained computing device. The models selected by the model compression unit 126 are installed on and executed by the resource-constrained computing device to provide ink stroke analysis services that would otherwise be implemented on the application services platform 110.

FIG. 6C is an example flow chart of an example process 670 for processing ink stroke information in an ink stroke pipeline according to the techniques described herein. The process 670 can be implemented by the ink processing pipeline 124 and/or the model compression unit 126 of the application service platform 110.

The process 640 includes an operation 672 of obtaining, via a digital ink processing pipeline, digital ink stroke information representing handwritten text. As discussed in the preceding examples, the ink processing pipeline 124 receives input ink strokes 202 input by a user of the native application 114 or the web application 190, and the stroke classification unit 204 analyzes the input ink strokes to identify the digital ink stroke information associated with handwriting and the digital ink stroke information associated with drawings. The digital ink stroke information associated with handwriting is provided to the writing layout analysis unit 206 to determine the layout of the handwriting.

The process 640 includes an operation 674 of analyzing the digital ink stroke information using a temporal line grouping model trained to receive the digital ink stroke information as an input and to output information identifying lines of text represented in the digital ink stroke information. The temporal line grouping unit 272 of the writing analysis unit 206 implements the temporal line grouping model. The temporal line grouping model analyzes the sequence in which each ink stroke comprising the digital ink stroke information was input to identify lines of text included in the handwriting.

The process 640 includes an operation 676 of determining a layout of the handwritten text based at least in part on the information identifying lines of text output by the temporal line grouping model. Additional processing may be preformed on the line grouping information output by the temporal line grouping model to determine a layout of the handwritten text. For example, the lines may be grouped into writing regions that may include paragraphs, lists, and/or other groupings of text. These groupings may be based at least in part on a semantic analysis of the textual content to group text having similar semantic meanings together. Additional processing may be performed on the handwriting in addition to these examples. Furthermore, the handwriting and/or a textual representation of the handwriting may be presented on a user interface of the native application 114 and/or on the web application 190 in some implementations.

The detailed examples of systems, devices, and techniques described in connection with FIGS. 1-6C are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-6C are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

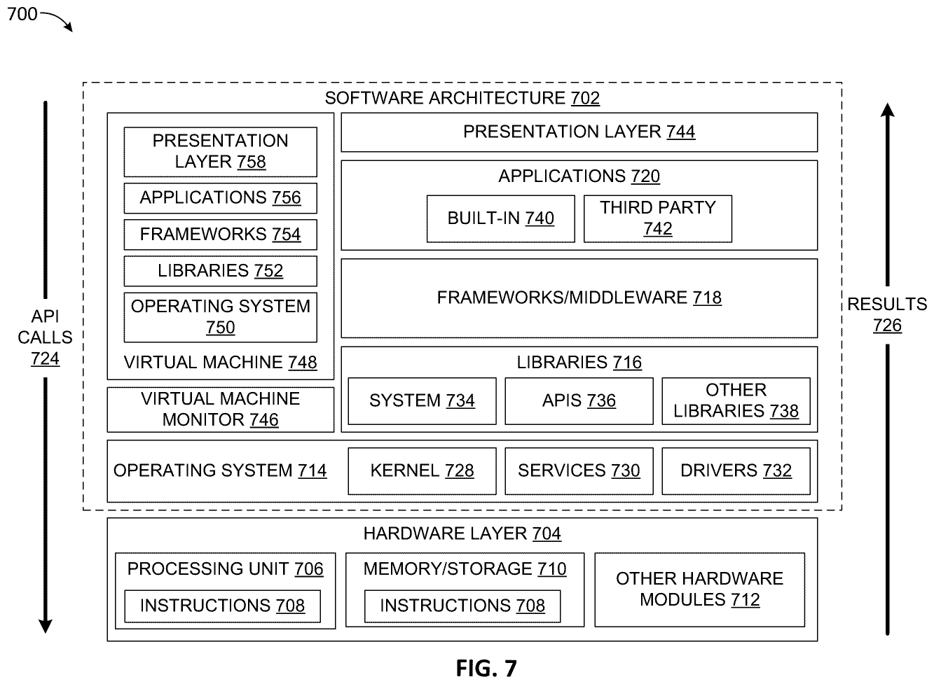

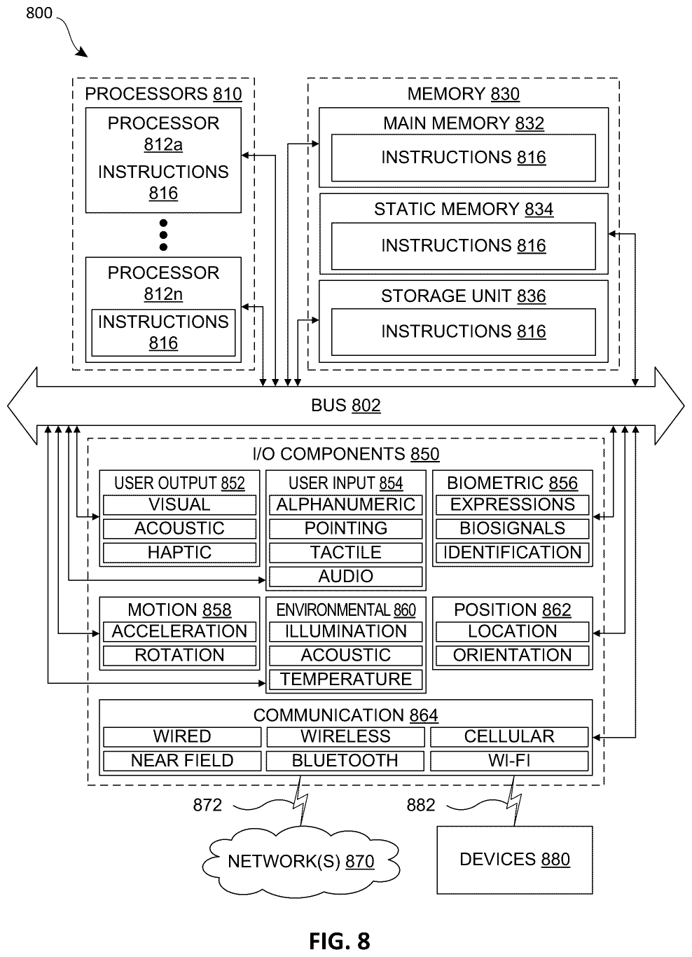

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a machine-readable medium storing executable instructions that, when executed, cause the processor alone or in combination with other processors to perform operations comprising:
obtaining, via a model compression unit, device information and performance requirements information for a resource-constrained computing device;
analyzing, via the model compression unit, the device information and the performance requirements information to determine an amount to compress one or more machine learning models to permit the resource-constrained computing device to operate the one or more machine learning models on the resource-constrained computing device;
compressing, via the model compression unit, the one or more machine learning models to permit the one or more machine learning models to operate on the resource-constrained computing device to generate one or more compressed machine learning models by altering a structure of the one or more machine learning models to require fewer resources when executed than an uncompressed version of the one or more machine learning models; and
deploying the one or more compressed machine learning models to the resource-constrained computing device to process ink stroke information captured by a user interface of the resource-constrained computing device.

2. The data processing system of claim 1, wherein the device information comprises processor type information, device memory information, and device storage information, and wherein the performance requirements information comprises model latency requirements, model size requirements, and model accuracy requirements.

3. The data processing system of claim 1, wherein the machine-readable storage medium further includes instructions configured to cause the processor alone or in combination with other processors to perform operations of:
training the one or more machine learning models to process the ink stroke information, wherein at least one of the one or more machine learning models is a stroke classification model.

4. The data processing system of claim 1, wherein the resource-constrained computing device lacks sufficient computing resources to operate an instance of the one or more machine learning models.

5. The data processing system of claim 1, wherein the one or more machine learning models includes a convolutional neural network (CNN).

6. The data processing system of claim 1, wherein compressing the one or more machine learning models further comprises:
replacing a standard convolution layer of a machine learning model of the one or more machine learning models with a depthwise separable convolution layer.

7. The data processing system of claim 1, wherein compressing the one or more machine learning models further comprises:
reducing a size of a convolution layer of a machine learning model of the one or more machine learning models by eliminating one or more filters from the convolution layer.

8. The data processing system of claim 1, wherein compressing the one or more machine learning models further comprises:
quantizing a convolution layer of a machine learning model of the one or more machine learning models by converting an input having a first bit width to the convolution layer to a second bit width prior to performing matrix calculations in the convolution layer, the second bit width being lower than the first bit width.

9. The data processing system of claim 8, wherein the machine-readable storage medium further includes instructions configured to cause the processor alone or in combination with other processors to perform operations of:
modifying the convolution layer to include an input conversion layer for converting the input from the first bit width to the second bit width and an output conversion layer for converting the output from the second bit width to the first bit width.

10. The data processing system of claim 1, wherein compressing the one or more machine learning models further comprises:
generating a graph representing an architecture of a machine learning model of the one or more machine learning models;
modifying the graph of the architecture of the machine learning model to generate an optimized graph of the architecture of the machine learning model; and
compressing the machine learning model by modifying the architecture according to the optimized graph.

11. A method implemented in a data processing system for generating compressed versions of machine learning models, the method comprising:
obtaining device information for a resource-constrained computing device, wherein the resource-constrained computing device lacks sufficient computing resources to operate an instance of the one or more machine learning models;
selecting a set of compressed machine learning models to be implemented on the resource-constrained computing device based on the device information and performance requirements information indicating performance constraints for compressed models to be implemented on the resource-constrained computing device, wherein the performance constraints include constraints on one or more of memory usage, latency, and model size; and
deploying the set of compressed machine learning models to the resource-constrained computing device to process ink stroke information captured by a user interface of the resource-constrained computing device.

12. The method of claim 11, wherein the resource-constrained computing device lacks sufficient computing resources to operate an instance of the one or more machine learning models.

13. The method of claim 11, wherein the one or more machine learning models comprises a convolutional neural network (CNN).

14. A data processing system comprising:
a processor; and
a machine-readable medium storing executable instructions that, when executed, cause the processor alone or in combination with other processors to perform operations comprising:
obtaining, via a digital ink processing pipeline, digital ink stroke information representing handwritten text;
analyzing the digital ink stroke information using a temporal line grouping model trained to receive the digital ink stroke information as an input and to output information identifying lines of text represented in the digital ink stroke information, the temporal line grouping model being analyzing a sequence in which each ink stroke comprising the digital ink stroke information was input; and
determining a layout of the handwritten text based at least in part on the information identifying lines of text output by the temporal line grouping model.

15. The data processing system of claim 14, wherein the temporal line grouping model is implemented by a Gated Recurrent Unit (GRU)-based recurrent neural network (RNN).

16. The data processing system of claim 15, wherein the machine-readable storage medium further includes instructions configured to cause the processor alone or in combination with other processors to perform operations of:
compressing the temporal line grouping model using a model compression unit to generate a compressed instance of the temporal line grouping model to be implemented on a resource-constrained device, and wherein the resource-constrained computing device lacks sufficient computing resources to operate an uncompressed instance of the temporal line grouping model.

17. The data processing system of claim 16, wherein compressing the temporal line grouping model comprises altering a structure of the one or more machine learning models to require fewer resources when executed than the uncompressed version of the temporal line grouping model.

18. The data processing system of claim 16, wherein compressing the temporal line grouping model comprises one or more of removing one or more layers from the uncompressed instance of the temporal line grouping model or removing one or more hidden units from one or more layers of the uncompressed instance of the temporal line grouping model.

19. The data processing system of claim 16, wherein compressing the temporal line grouping model further comprises analyzing, via the model compression unit, device information and performance requirements information associated with the resource-constrained device to determine an amount to compress the temporal line grouping model.

20. The data processing system of claim 19, wherein the device information comprises processor type information, device memory information, and device storage information, and wherein the performance requirements information comprises model latency requirements, model size requirements, and model accuracy requirements.
